(19) United States
(12) Patent Application Publication
(10) Pub. No.: US 2013/0324270 A1
(43) Pub. Date: Dec. 5, 2013

(54) MANUFACTURING METHOD AND EQUIPMENT FOR INTENSIFYING HARDNESS OF SCREWS

(71) Applicant: CHENG-YUAN WU, TAINAN CITY (TW)

(72) Inventor: CHENG-YUAN WU, TAINAN CITY (TW)

(21) Appl. No.: 13/572,320

(22) Filed: Aug. 10, 2012

(30) Foreign Application Priority Data
Jun. 4, 2012 (TW) 101119993

(51) Int. Cl. B21H 3/02; B23G 9/00

(52) U.S. Cl. 470/9; 470/58

(57) ABSTRACT

A manufacturing method and equipment for intensifying hardness of screws includes at least three steps. A first step is to have a steel wire forged into a first blank with a screw head and a screw shank. A second step is to convey the first blank into a thread shaping die to have the outer diameter of the shank of the first blank diminished to form a second blank through the first sectional cold forging region of the thread shaping die for intensifying the hardness of the shank. A third step is to have the second blank directly moved into the second sectional thread-forming region of the thread shaping die to shape threads and a pointed tail of the shank. Thus, both the second step and the third step can be carried out within the same thread shaping die, able to elevate shaping speeds and hardness of screws.

### CROSS-REFERENCE TO RELATED APPLICATIONS

This application claims the priority benefits of Taiwan application No. 101119993 filed on Jun. 4, 2012, the contents of which are hereby incorporated by reference in its entirety.

### BACKGROUND OF THE INVENTION

1. Field of the Invention

This invention relates to a manufacturing method and equipment for intensifying hardness of screws, particularly to one having a second step of reinforcing hardness of the shank of a screw and a third step of forming threads of the screw integrated and completed in a same thread shaping die, able to elevate shaping speeds and hardness of screws.

2. Description of the Prior Art

A conventional method for manufacturing screws, as disclosed in a Taiwan patent NO. 1320340, titled “Method For Cold Forging Austenite 300 Series To Produce Fasteners With Super High Intensity” includes a first step of preparing a first blank made of Austenite 300 series. The blank is first cold forged to diminish the outer diameter of the blank over 15% to form a second shank whose outer diameter is equal to an outer diameter needed to be processed. At this time, the bearable strength of the second shank increases at least over one half in comparison with the strength of the first blank and sequentially, this shank is to be shaped with a head, a pointed tail and threads of a screw. Therefore, by using cold forging methods, screws having great strength and excellent in rust prevention can quickly be manufactured, able to lower manufacturing cost and insure safety in use after the screws are drilled into articles and locked.

Apparently, the conventional method for manufacturing screws is first to have the outer diameter of the shank diminished about 15% for facilitating the shank to be shaped at different stages subsequently. According to the conventional method of manufacturing screws, only when four steps: a step of preparing a blank, a step of forming a head, a step of forming a pointed tail and a step of forming threads, are completed one by one, can a drilling screw be manufactured. Substantially, the more the shaping steps of a screw are, the lower the shaping speed will be, thus increasing manufacturing cost and decreasing competitive force in industry.

### SUMMARY OF THE INVENTION

The objective of this invention is to offer a manufacturing method and equipment for intensifying hardness of screws, able to simplify screw shaping processes and reinforce the strength of screw shanks for strengthening locking force of screws.

The manufacturing method for intensifying hardness of screws in the present invention includes at least three steps. A first step is to have a steel wire forged to make up a first blank formed with a screw head and a screw shank. A second step is to convey the first blank into a thread shaping die to have the outer diameter of the shank of the first blank diminished to form a second blank through a first sectional cold forging region for reinforcing the hardness of the shank. A third step is to have the second blank directly moved into a second sectional thread forming region of the thread shaping die to be shaped with threads and pointed tail at one time. By so designing, both the second step of reinforcing the hardness of the shank and the third step of forming threads can be carried out within the thread shaping die, needless to be removed out of the thread shaping die, thus elevating shaping speeds and hardness of screws.

The equipment for intensifying hardness of screws in the present invention includes the thread shaping die provided with the first sectional cold forging region and a second sectional thread forming region. The first sectional cold forging region functions to carry out the motion of the second step for diminishing the outer diameter of the shank of the first blank for reinforcing the hardness of the shank while the thread forming region functions to carry out the motion of the third step for shaping threads of the shank and the pointed tail of a screw with one round. Thus, the motions of both the second step and the third step can be carried out within the same thread shaping die, able to enhance shaping speeds and hardness of a screw.

### BRIEF DESCRIPTION OF DRAWINGS

This invention will be better understood by referring to the accompanying drawings, wherein:

FIG. 1 is a flow chart of a first preferred embodiment of a manufacturing method and equipment for intensifying hardness of screws in the present invention;

FIG. 2 is schematic view of the first preferred embodiment of the manufacturing method and equipment for intensifying hardness of screws in the present invention, illustrating a second step of having a first blank conveyed into a thread rolling die to make a second blank;

FIG. 3 is a schematic view of the first preferred embodiment of the manufacturing method and equipment for intensifying hardness of screws in the present invention, illustrating a third step of having the second blank moved into a thread forming region of the thread rolling die to be shaped with threads and a pointed tail;

FIG. 4 is a flow chart of a second preferred embodiment of a manufacturing method and equipment for intensifying hardness of screws in the present invention;

FIG. 5 is a flow chart of a third preferred embodiment of a manufacturing method and equipment for intensifying hardness of screws in the present invention; and

FIG. 6 is a flow chart of a fourth preferred embodiment of a manufacturing method and equipment for intensifying hardness of screws in the present invention.

### DETAILED DESCRIPTION OF THE PREFERRED EMBODIMENT

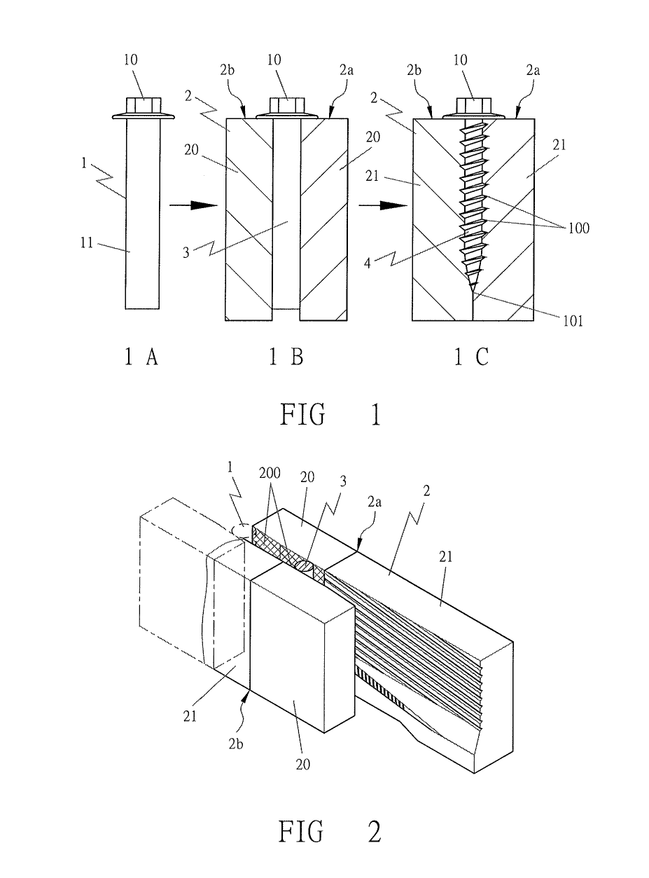

A first preferred embodiment of a manufacturing method and equipment for intensifying hardness of screws in the present invention, as shown in FIGS. 1-3, includes at least three steps:

A first step is to have a steel wire forged into a first blank 1 formed with a screw head 10 and a screw shank 11, as shown in 1A of FIG. 1. The screw head 10 can be made into various suitable shapes in accordance with practical needs.

A second step is to have the first blank 1 conveyed into a thread shaping die 2, which is composed of a fixed thread shaping die 2a and a movable thread shaping die 2b, as shown in FIG. 2. The thread shaping die 2 is provided with a first sectional cold forging region 20 with rough surfaces 200 for preventing the first blank 1 from slipping therein. Thus, when the first blank 1 is moved in between the fixed thread shaping die 2a and the movable thread shaping die 2b of the thread shaping die 2 to be rolled and pressed by the movable thread shaping die 2b, the outer diameter of the shank 10 of the first blank 1 can be diminished to form a second blank 3, as shown in 1B of FIG. 1, so as to reinforce the hardness of the shank 10. The ratio of diminished outer diameter of the shank 10 is decided according to practical need.

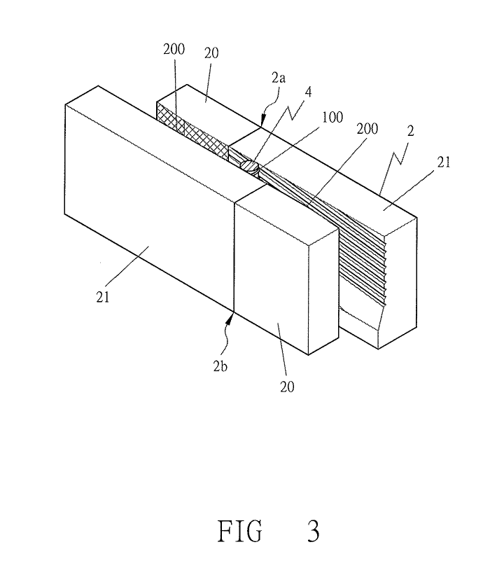

A third step is to have the second blank 3 directly pushed forward to get into a second sectional thread-forming region 21 of the thread rolling die 2 by the motion of the movable thread shaping die 2b, as shown in 1C of FIG. 1 and in FIG. 3. Thus, the threads 100 and the pointed tail 101 of the shank 10 can be shaped at one time by means of the second sectional thread-forming region 21 to produce a screw 4.

By so designing, both the motions of the second step of intensifying the hardness of the shank and the third step of forming threads can be completed with one round within the thread shaping die 2, able to enhance screw shaping speeds and intensify the hardness of the screw.

A second, a third and a fourth preferred embodiments of a manufacturing method and equipment for intensifying hardness of screws in the present invention, as shown in FIGS. 4-6, is the same as the first preferred embodiment in a first step of preparing the first blank 1 formed with the screw head 10 and the screw shank 11.

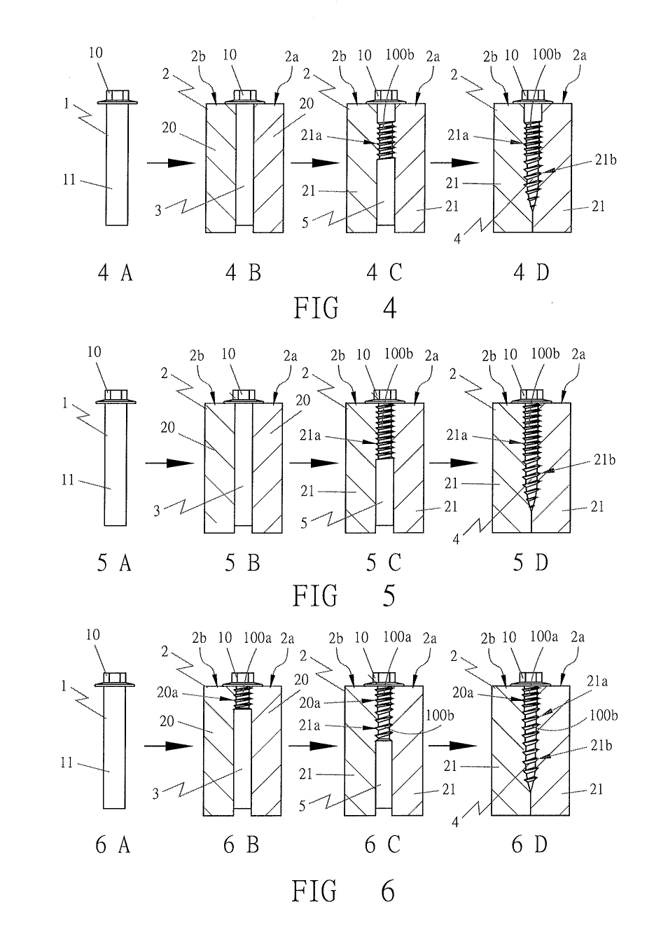

In the second and the third preferred embodiments, a second step is to have the thread shaping die 2, which is the same as that described in the first preferred embodiment, provided with a first sectional cold forging region 20 for shaping a second blank 3, as shown in 4B of FIGS. 4 and 5B of FIG. 5. In the fourth preferred embodiment, a second step is to have the thread shaping die 2 provided with a first sectional cold forging region 20 and further disposed with a small sectional thread shaping region 20a for making up a second blank 3 containing a length of threads 100a.

A third step is to have the thread rolling die 2 disposed with a small sectional thread shaping region 21a at different locations according to practical needs for producing a third blank 5 that contains a short length of threads 100b, as shown in 4C of FIG. 4, SC of FIGS. 5 and 6C of FIG. 6. In the third preferred embodiment, the small sectional thread shaping region 21a of the thread shaping dies 2 must be continuously connected with the small sectional thread shaping region 20a of the first sectional cold forging region 20 to form different shapes of threads at the upper and the lower portions for producing a third blank 5 comprising plural small sectional threads 100a and 100b.

A fourth step is to have the thread shaping die 2 provided with an end sectional thread shaping region 21b, which has to be continuously connected with the small-sectional thread-shaping region 21a for producing a screw 4 with different shapes of threads.

Thus, even if the thread shaping die is made into a second step, a third step and a fourth step in shape for orderly producing the second blank, the third blank and the screw, both the second blank and the third blank still will not depart from the thread shaping die, able to enhance the shaping speed and the hardness of screws.

While the preferred embodiments of the invention have been described above, it will be recognized and understood that various modifications may be made therein and the appended claims are intended to cover all such modifications that may fall within the spirit and scope of the invention.

What is claimed is:

1. A manufacturing method for intensifying hardness of screws comprising:
a first step of having a steel wire forged into a first blank, said first blank formed with a screw head and a screw shank;
a second step of conveying said first blank into a thread shaping die, said shank of said first blank having an outer diameter diminished to form a second blank through a first sectional cold forging region for intensifying the hardness of said shank;
a third step of having said second blank directly moved into a second sectional thread forming region of said thread shaping die, threads and pointed tail of said shank able to be shaped with one round to complete producing a screw through said second sectional thread-forming region; and
wherein said second blank that is shaped at said second step is unnecessary to be removed out of said thread shaping die, said second blank is able to be directly moved into said second sectional thread forming region of said thread shaping die to carry out said third step of shaping a screw, intensification of hardness and formation of threads of said shank is able to be completed with one round for elevating shaping speeds and hardness of screws.

2. A manufacturing method for intensifying hardness of screws comprising:
a first step of forging a steel wire into a first blank, said first blank formed with a screw head and a screw shank;
a second step of conveying said first blank into a thread shaping die, said shank of said first blank having outer diameter diminished through a first sectional cold forging region to form a second blank for strengthening the hardness of said shank;
a third step of moving said second blank directly into a second small sectional thread forming region of said thread shaping die to make up a third blank containing a length of threads; and
a fourth step: having said third blank manufactured into a screw with different shapes of threads at each section through an end sectional thread forming region of said thread shaping die; and
whereinsaid second blank that is shaped at said second step is unnecessary to depart from said thread shaping die, said second blank is able to be directly moved into a second sectional thread forming region of said thread shaping die at said third step to produce a third blank, said third blank is needless to depart from said thread shaping die and able to directly get into said end sectional thread forming region of said thread shaping die of said fourth step to be made finally into a screw, intensification of hardness and shaping threads of said shank is completed with one round, able to elevate shaping speed and hardness of screws.

3. The manufacturing method for intensifying hardness of screws as claimed in claim 2, wherein said second step can produce said second blank containing a short length of threads.

4. The manufacturing method for intensifying hardness of screws as claimed in claim 2, wherein said third step can produce said third blank with plural small sectional threads.

5. The manufacturing method for intensifying hardness of screws as claimed in claim 2, wherein a finished screw can be made into plural sectional threads with different shapes at an upper portion and a lower portion.

6. The manufacturing method for intensifying hardness of screws as claimed in claim 1, wherein said second step can produce said second blank containing a short length of threads.

7. Equipment for intensifying hardness of screws at least comprising a thread shaping die, said thread shaping die provided with a first sectional cold forging region, said first sectional cold forging region functioning to produce a second blank with a diminished shank diameter, a second sectional thread forming region provided behind said first sectional cold forging region, said second sectional thread forming region employed to manufacture a finished screw, in a screw shaping process said second blank being unnecessary to be removed from said thread shaping die for elevating screw shaping speeds.

8. The equipment for intensifying hardness of screws as claimed in claim 7, wherein a surface of said first sectional cold forging region of said thread shaping die is a rough surface for preventing said first blank from slipping therein.

9. The equipment for intensifying hardness of screws as claimed in claim 7, wherein said first sectional cold forging region of said thread shaping die is provided with a small-sectional thread-forming region for producing said second blank containing a short length of threads.

10. The equipment for intensifying hardness of screws as claimed in claim 7, wherein said second sectional thread-forming region of said thread shaping die is provided with a small-sectional thread-forming region for producing said third blank containing a short length of threads.

11. The equipment for intensifying hardness of screws as claimed in claim 7, wherein said thread shaping die is provided with an end sectional thread-forming region to make up a screw containing plural sections of different-shaped threads.
